(19) United States
(12) Patent Application Publication
(10) Pub. No.: US 2011/0187256 A1
(43) Pub. Date: Aug. 4, 2011

(54) MULTIPURPOSE LIGHTING UNIT

(75) Inventors: Vineet Tyagi, Corning, NY (US); Jack Baldrige, Hammondsport, NY (US); Utsawa Chaturvedi, Rochester, NY (US); Mark Morrell, Bath, VA (US); Karl Baker, Dundee, NY (US); Rebecca Ketchum, Hammondsport, NY (US); Eswara Vallabhaneni, Elmira, NY (US); Georg Henninger, Aachen (DE)

(73) Assignee: KONINKLIJKE PHILIPS ELECTRONICS, N.V., EINDHOVEN (NL)

(21) Appl. No.: 11/721,988

(22) PCT Filed: Nov. 29, 2005
(86) PCT No.: PCT/IB2005/053955

§ 371 Date: Feb. 24, 2011

Related U.S. Application Data
(60) Provisional application No. 60/637,371, filed on Dec. 17, 2004.

(51) Int. Cl. H01J 61/92

(52) U.S. Cl. 313/1

(57) ABSTRACT

A three way lighting unit is provided for insertion in a lighting socket. The unit includes first and second lamps for selectively providing either wider area illumination of a first intensity and/or narrower area illumination of a second intensity. The first intensity is a lower intensity and the second intensity is a higher intensity in response to a concurrent energizing of the first and second lamps by a three-way switch.

This application claims priority to U.S. Provisional Patent Application 60/637,371 filed on Dec. 17, 2004, and entitled “MULTIPURPOSE LIGHTING UNIT”.

This invention relates to a multipurpose lighting unit that addresses a variety of user needs. Principally these include differing brightness levels, color temperatures, optical directability (e.g. spot lighting and flood lighting), energy efficiencies, purchase costs, and operating lives.

A type of lighting that addresses many of these needs is the light-emitting diode (LED) technology, which is capable of providing varying brightness, color and optical directability. LEDs are also becoming increasingly efficient and have very long operating lives. However, this technology is expensive relative to types of lighting that are commonly in use, e.g. incandescent, fluorescent and high-intensity discharge lighting. Further, LEDs have limited color rendering capability. A less expensive alternative to LED technology is desirable.

In accordance with the present invention, a lighting unit is provided which includes first and second lamps arranged for cooperatively providing lighting in a common space. The first lamp produces a wider area illumination of a first intensity and the second lamp produces a narrower area illumination of a second intensity whereby the lamp intensities can be fixed or variable. A three-way switch is provided for selectively energizing either or both of the lamps, wherein the first intensity is a lower intensity and the second intensity is a higher intensity in response to both lamps being concurrently energized by the three-way switch. A connector is provided for plugging the unit into a power source. This single unit can be plugged into a fixture (e.g., a screw-in socket or bayonet socket) to provide a choice of light level and type.

In one form of the invention, the lighting unit includes a discharge lamp (e.g., a fluorescent or high-intensity-discharge lamp) and a halogen lamp. The discharge lamp produces a flood-lighting effect for illuminating a larger area in the space when energized. The halogen lamp produces a spot-lighting effect for illuminating a smaller area in the space when energized.

Various combinations of discharge and halogen lamps can be provided to take advantage of their different efficiencies, intensities and color rendering indices. For example, in a fluorescent/halogen lighting unit the user can choose from the higher efficiency of the fluorescent lamp, the higher brightness of the halogen lamp, or the combination of both. Further, both discharge and halogen lamps typically have long lives and the life of a halogen lamp can be further extended by using a low-voltage burner. Combinations of halogen lamps only can also offer advantages. Lighting units including more than two lamps are also possible.

Additional cost efficiencies arise from the advantage that already-available lamp components found in lamps on the market may be utilized in the lighting unit to minimize development costs. In one advantageous form of the lighting unit, either or both of the lamps may be controllably dimmed, thus decreasing operating cost while enabling the light level to be adjusted to a desired level. These and other features of the lighting unit may be chosen by the manufacturer so as to provide a variety of functional and decorative accent features that are not available with other lamps on the market.

The foregoing and other features and advantages of the present invention will become further apparent from the following detailed description of exemplary embodiments, read in conjunction with the accompanying drawing figures. The detailed description and drawing figures are merely illustrative of the present invention rather than limiting, the scope of the present invention being defined by the appended claims and equivalents thereof:

FIGS. 1-5 are schematic illustrations of exemplary embodiments of lighting units in accordance with the present invention;

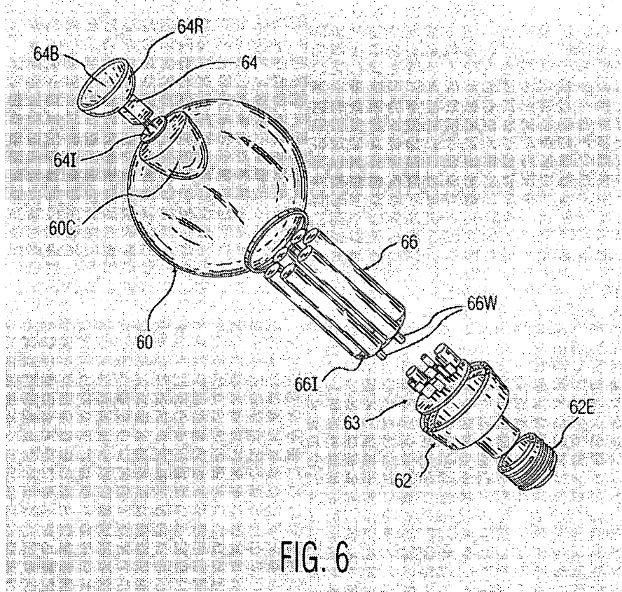

FIG. 6 is an exploded three-dimensional view of an exemplary spherical envelope, halogen/linear-fluorescent lighting unit in accordance with the present invention;

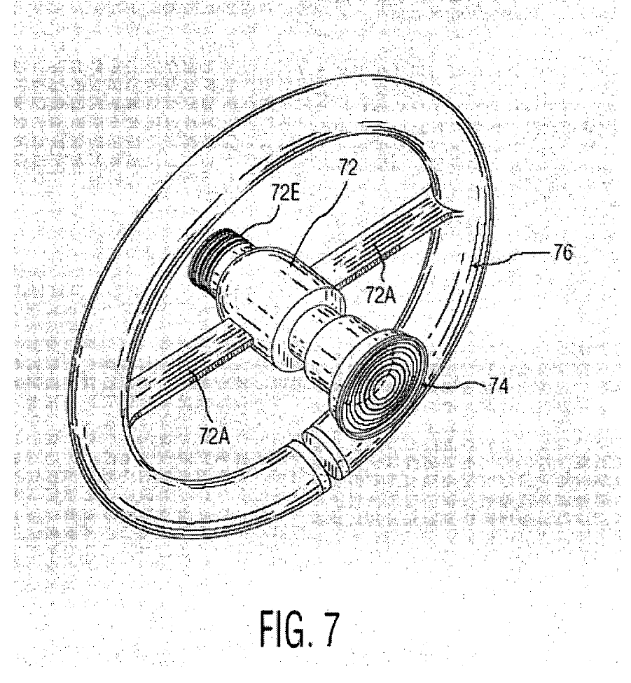

FIG. 7 is a three-dimensional view of an exemplary spot lamp/circular-fluorescent lighting unit in accordance with the present invention;

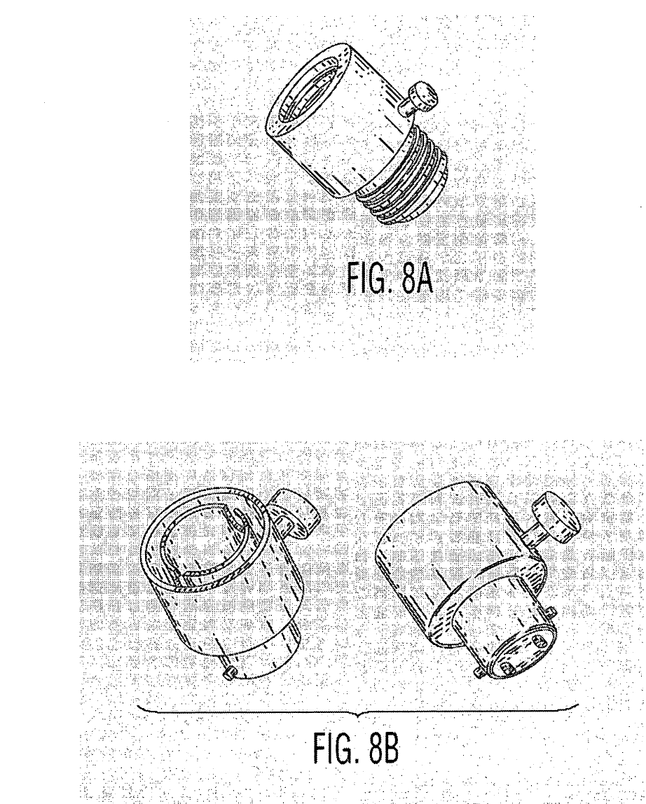

FIGS. 8A and 8B are three-dimensional illustrations of first and second adapters for use with lighting units in accordance with the present invention;

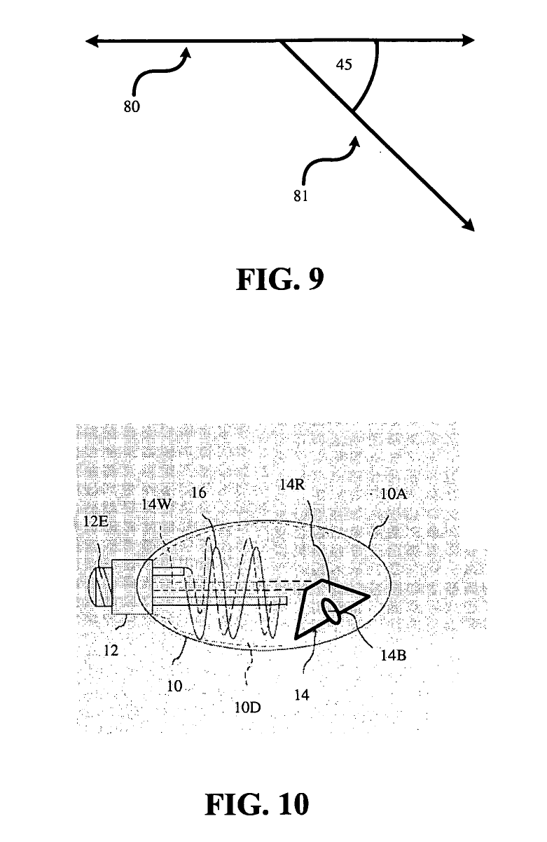

FIG. 9 is a plane view of a 45 degree intersection angle of two lamp symmetry axes;

FIG. 10 is a schematic illustration of an exemplary embodiment of a lighting unit having 45 degree intersection angle of two lamp symmetry axes in accordance with the present invention;

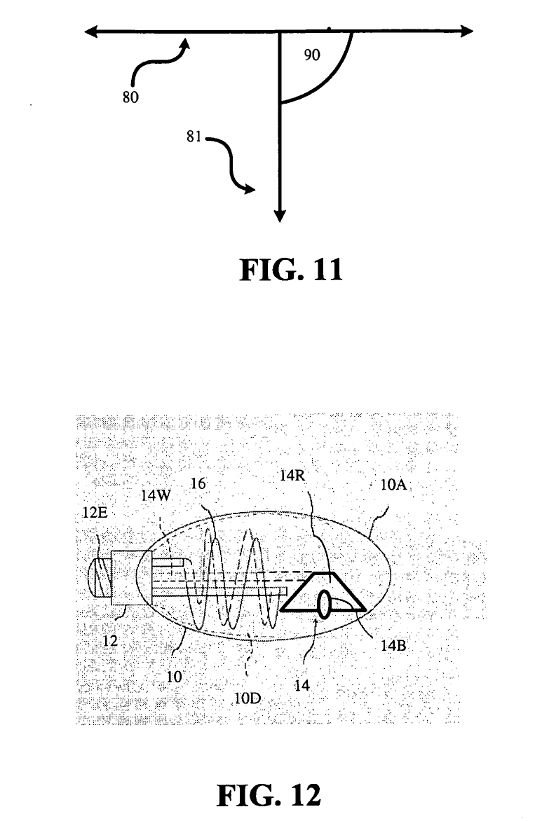

FIG. 11 is a plane view of a 90 degree intersection angle of two lamp symmetry axes;

FIG. 12 is a schematic illustration of an exemplary embodiment of a lighting unit having 90 degree intersection angle of two lamp symmetry axes in accordance with the present invention;

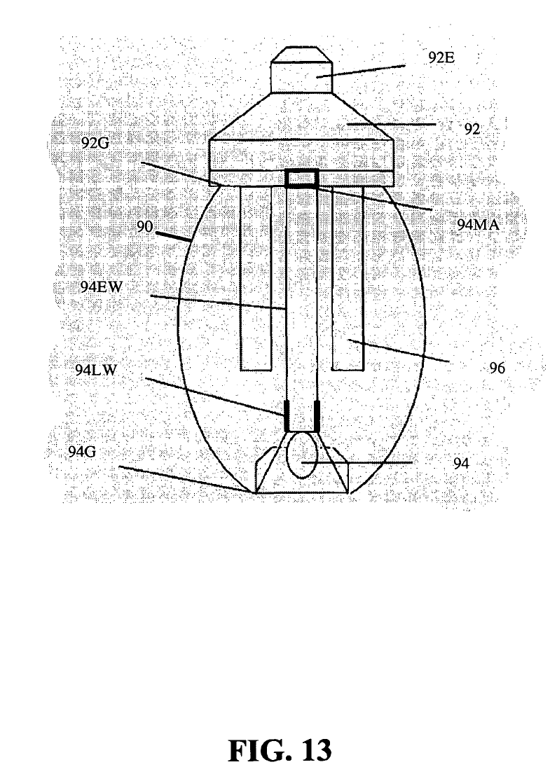

FIG. 13 is a schematic illustration of an exemplary embodiment of a lighting unit employing a safety feature in accordance with the present invention; and

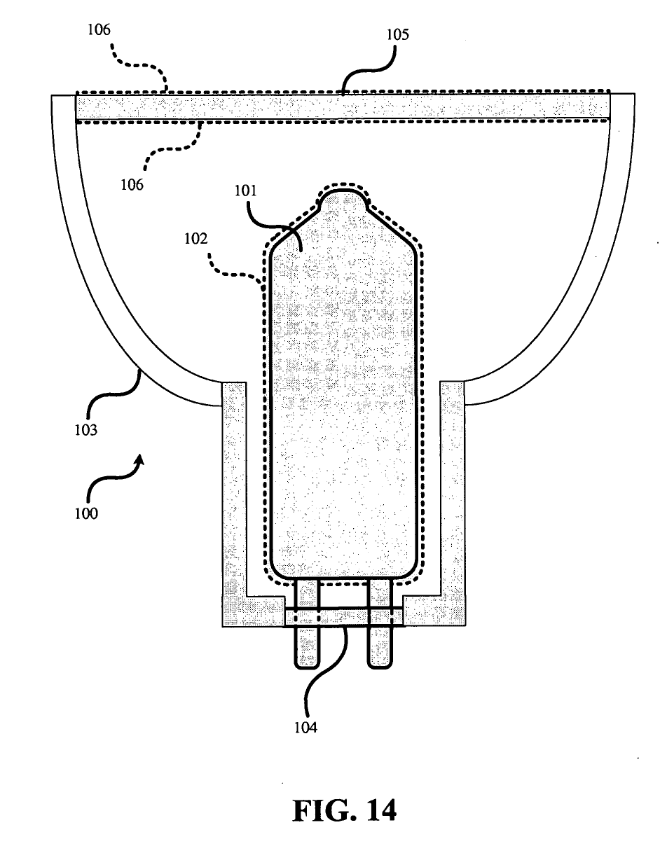

FIG. 14 is a schematic illustration of an exemplary embodiment of halogen reflector lamp in accordance with the present invention.

FIG. 1 schematically illustrates an exemplary lighting unit in accordance with the present invention as including an elliptical envelope 10 attached to a base 12 and containing a halogen lamp 14 and a fluorescent lamp 16. In this illustration, the fluorescent lamp has a spiral-shaped tube, but any shape that fits within the envelope may be utilized.

The envelope 10 consists essentially of any glass or plastic material that is substantially transparent to light produced by the halogen and fluorescent lamps. A light-diffusive coating 10D is disposed on part of the inner surface of the envelope to diffuse light emitted by the fluorescent lamp 16. Alternatively, this coating may be disposed on the outer surface or may be eliminated entirely. If provided, the coating may also be colored to filter the light passing through it and produce a decorative or mood-enhancing effect.

The halogen lamp 14 is conveniently a standard type (e.g., a MR11, MRC11, MR16 or a MRC16). This lamp includes a burner 14B positioned partially within a reflector 14R that is disposed adjacent an uncoated output end 10A of the envelope. The position of the burner within the reflector and/or the shape of the reflector can be changed by the manufacturer to achieve the desired beam characteristics.

The fluorescent lamp 16 is conveniently a standard type of compact fluorescent lamp (CFL). It comprises a burner having a tube of any one of a variety of shapes (e.g., linear, folded/U-shaped, spiral/helical etc.). An electronic ballast (not shown) is contained in the base 12 for providing the high voltage and current limiting needed for ignition and current control of the fluorescent burner. As is well known in the art, the ballast may be powered to provide a substantially constant light output or may be a dimming type for controllably powering the fluorescent burner or the halogen burner to produce less than full light output.

The base 12 further includes a connector portion for electrically connecting the lighting unit to an AC power source (e.g., a 120 or 220 VAC line voltage) and a three-way switch (not shown) for selectively powering either or both of the halogen and fluorescent burners. In FIG. 1 the connector portion comprises an Edison screw base portion 12E, although any type of connector may be utilized. The three-way switch (not shown) may be a relatively inexpensive standard electro-mechanical switch installed in the base. Alternatively, the three-way switch may be provided in the form of a semiconductor switching circuit to enable remote control of the lighting unit (e.g., via a signal transmitted over the power line or via a wireless remote control device, such as an IR or RF transmitter).

In one particularly advantageous form, the base 12 further contains a converter for powering a low-voltage halogen burner, i.e. one that operates at a voltage that is substantially below the commonly-available line voltages that are generally in the range of 120 to 230 volts. Such low-voltage halogen burners are popular because, relative to higher-voltage halogen burners, they have a higher efficiency, longer life, improved color rendering indices, and are more rugged. Examples of a low-voltage converter and exemplary halogen burners that may be advantageously used are described in U.S. Patent Application 60/602,582 filed on 18 Aug. 2004 (attorney docket number US 040330), which is hereby incorporated by reference.

A pair of wires 14W is provided to electrically connect the halogen burner 14B, via the three-way switch, to the power source or, if provided, to the low-voltage converter. The fluorescent lamp 16 is electrically connected, via the three-way switch, to the ballast.

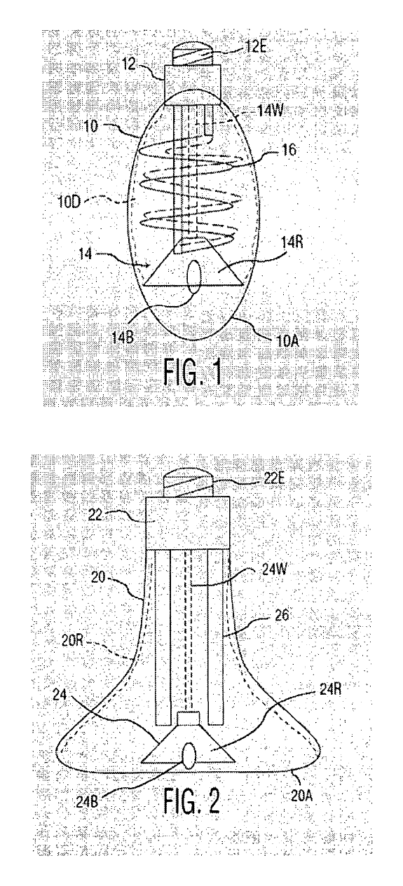

FIG. 2 schematically illustrates an exemplary lighting unit in accordance with the present invention that is generally similar to that of FIG. 1, but has a bell-shaped envelope 20 attached to a base 22. The envelope contains a halogen lamp 24 and a fluorescent lamp 26 having a plurality of linear tubes.

The envelope 20 has a light-reflective coating 20R on part of its inner surface. This surface has a parabolic shape for reflecting light emitted by the fluorescent lamp 26 toward an uncoated end 20A of the envelope. Alternatively, this light-reflective coating may be disposed on the outer surface. In one advantageous embodiment, a dichroic reflective coating may be utilized. Dichroic coatings are wavelength selective and offer the further capability of reflecting light of a specific color, if desired.

The halogen lamp 24 in this embodiment is substantially the same as that in FIG. 1 and includes a burner 24B positioned partially within a reflector 24R that is disposed adjacent the uncoated output end 20A of the envelope. The position of the burner within the reflector and/or the shape of the reflector can be changed by the manufacturer to achieve the desired beam characteristics.

This embodiment (and all other embodiments shown in the figures) may include circuitry in the base (or elsewhere) for providing, controlling and switching power to the different lamps in the envelope, as is described in connection with FIG. 1. Similarly, a base 22 includes a connector portion 22E for electrically connecting the lighting unit to a power source. Also, a pair of wires 24W are provided for electrical connections to the halogen burner 24B.

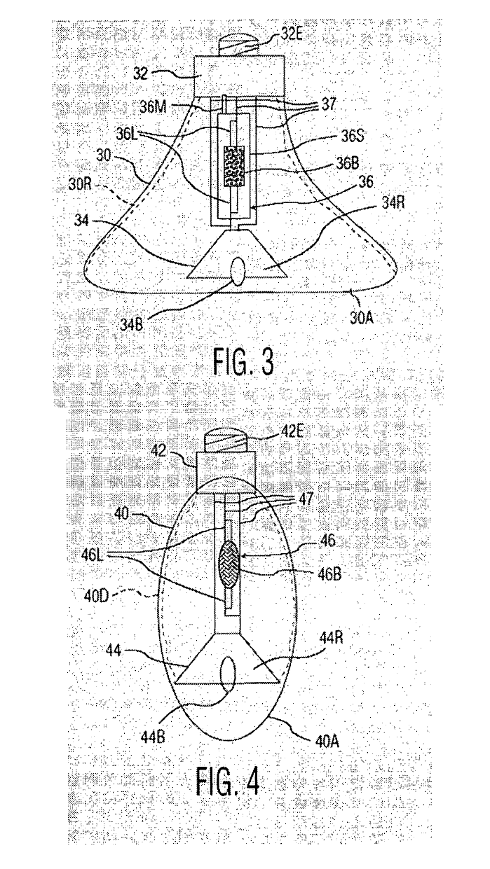

FIG. 3 schematically illustrates an exemplary lighting unit in accordance with the present invention that has a bell-shaped envelope 30 generally similar to that of FIG. 2, but includes a high-intensity-discharge (HID) lamp 36 attached to a base 32 by means of an intermediate metallic member 36M of, for example, a nickel-iron alloy. An HID lamp is generally smaller than a compact fluorescent lamp (CFL), while still having a comparable efficiency for the same light output and good color-rendering capability. It also has a higher brightness capability than CFL. The envelope 30 also contains a halogen lamp 34, similar to the lighting unit of FIG. 2.

The HID lamp 36 is conveniently a ceramic metal halide type. It comprises a sealed tubular protective shroud 36S of glass, quartz or other light transmissive material surrounding a metal halide burner 36B having protruding electrical leads 36L. These leads are electrically connected, via respective wires passing through walls of the shroud 36S, to two of three wires 37 that enter the base 32 for electrical connection to an electronic ballast. This ballast (not shown) is contained in the base 32 for providing the high voltage and current limiting needed for ignition and current control of the HID burner 36B. As is well known in the art, the ballast may be powered to provide a substantially constant light output or may be a dimming type for controllably powering the HID burner to produce less than full light output.

The envelope 30 has a light-reflective coating 30R on part of its inner surface. This surface has a parabolic shape for reflecting light emitted by the HID lamp 36 toward an uncoated end 30A of the envelope. Alternatively, this light-reflective coating may be disposed on the outer surface. Advantageously, a dichroic reflective coating may be utilized. Dichroic coatings are wavelength selective and offer the further capability of reflecting light of a specific color (or even reflecting IR radiation generated by the lamp 36) out of the envelope end 30A, if desired.

The halogen lamp 34 in this embodiment is substantially the same as that in FIG. 2 and includes a burner 34B positioned partially within a reflector 34R that is disposed adjacent the uncoated output end 30A of the envelope. The position of the burner within the reflector and/or the shape of the reflector can be changed by the manufacturer to achieve the desired beam characteristics. Advantageously, a dichroic reflective coating may be utilized on a surface of the reflector 34R. Such a coating offers the further capability of reflecting light of a specific color (or even reflecting IR radiation generated by the burner 34B) out of the envelope end 30A, if desired. Alternatively, colored light may be produced by providing a dichroic transmissive coating on the inner or outer surface of the burner 34B for passing light of the desired color.

The base 32 includes a connector portion 32E for electrically connecting the lighting unit to a power source. Two of the three wires 37 electrically connect the halogen burner 34B to the source of power or low-voltage converter via a three-way switch, as is described in connection with the exemplary embodiment of FIG. 1.

FIG. 4 schematically illustrates an exemplary lighting unit in accordance with the present invention that has an elliptical envelope 40 generally similar to that of FIG. 1, but includes a high efficiency halogen lamp 46. The envelope 40 also contains a halogen lamp 44, similar to the lighting unit of FIG. 3.

The halogen lamp 46 is conveniently an infrared reflecting halogen type. It comprises a burner 46B having a filament tube with protruding electrical leads 46L that are attached to a base 42 by support lead wires consisting essentially of a conductor material, such as a nickel-iron alloy. The high efficiency of this type of lamp is largely attributable to an infrared reflective (IRR) coating (such as a dichroic coating) on the outer surface of the halogen burner 46B, as is well known in the art.

The envelope 40 has a light-diffusive coating 40D on part of its inner surface to diffuse light emitted by the high-efficiency halogen lamp 46. Alternatively, this coating may be disposed on the outer surface or may be eliminated entirely. Further, the coating may be colored, if desired. Advantageously, a dichroic transmissive coating may be utilized for this purpose.

The halogen lamp 44 in this embodiment is substantially the same as that in FIG. 3 and includes a burner 44B positioned partially within a reflector 44R that is disposed adjacent the uncoated output end 40A of the envelope. The position of the burner within the reflector and/or the shape of the reflector can be changed by the manufacturer to achieve the desired beam characteristics. Also, colored light may be produced by utilizing dichroic or other coatings.

The base 42 includes a connector portion 42E for electrically connecting the lighting unit to a power source. The three wires 47 electrically connect each of the halogen burners 44B and 46B to the source of power or to a respective low-voltage converter via a three-way switch, as was described in connection with the exemplary embodiment of FIG. 1.

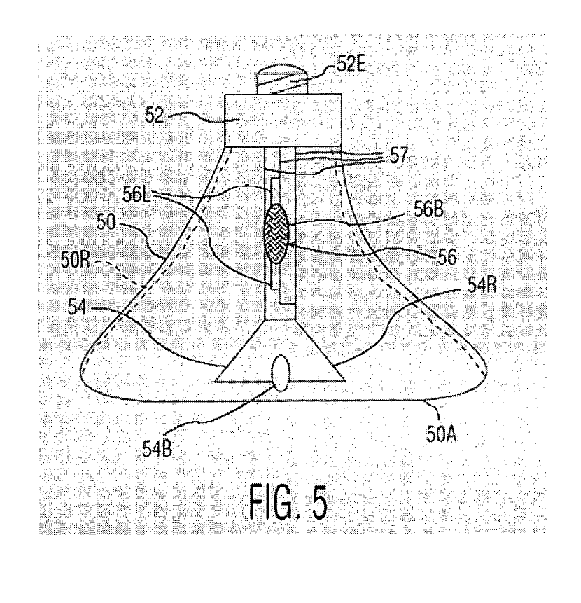

FIG. 5 schematically illustrates an exemplary lighting unit that is substantially identical to that of FIG. 4, but has a bell shaped envelope 50, similar to that of FIG. 2, with a light reflective coating 50R on part of its inner surface. This surface has a parabolic shape for reflecting light emitted by a high efficiency halogen lamp 56 toward an uncoated end 50A of the envelope. Alternatively, this coating may be disposed on the outer surface and may be colored, if desired. The envelope 50 also contains a halogen lamp 54, similar to the lighting unit of FIG. 4.

The halogen lamp 56 comprises a burner 56B having a filament tube with protruding electrical leads 56L that are attached to a base 52 by support lead wires consisting essentially of a conductor material, such as a nickel-iron alloy.

The halogen lamp 54 in this embodiment is substantially the same as lamp 44 in FIG. 4 and includes a burner 54B positioned partially within a reflector 54R that is disposed adjacent the uncoated output end 50A of the envelope.

The base 52 includes a connector portion 52E for electrically connecting the lighting unit to a power source. The three wires 57 electrically connect each of the halogen burners 54B and 56B to the source of power or to a respective low-voltage converter via a three-way switch, as was described in connection with the exemplary embodiment of FIG. 1.

FIG. 6 illustrates in more detail an exemplary lighting unit generally similar to that shown schematically in FIG. 2. The lighting unit of FIG. 6 includes an envelope 60, a base 62, a circuit board 63, a fluorescent lamp 66 and a halogen lamp 64. The envelope 60 is shown as having a spherical shape, but could have any shape desired for functional or aesthetic purposes. The base 62 includes a recessed annular surface for receiving and supporting the circuit board 63 and a tubular end for receiving and supporting an Edison conductive connector 62E.

The circuit board itself may include whatever circuitry is needed for the lamps included in the lighting unit. For example, it can include an electronic ballast for the fluorescent lamp 66, a low voltage converter for the halogen lamp 64 and an electronic three way switch for selectively powering either or both lamps.

The fluorescent lamp 66 is mounted on an insulating base 661 of, for example, mylar and includes a pair of conductors 66W for both physically and electrically connecting this lamp to the circuit board 63.

The halogen lamp 64 includes a cup-shaped reflector 64R of, for example, glass or plastic in which the halogen burner 64B is mounted. The reflector itself is mounted on an insulating base 64I of, for example, mica. The envelope 60 includes a recessed cup-shaped portion 60C for receiving the reflector and insulating base. When assembled, the envelope is seated within a rim of the base 62 surrounding the circuit board 63. A pair of wires connecting the halogen burner 64B to the circuit board 63 pass from terminals of the burner through the insulating base 64I, the center of the fluorescent lamp 66, the insulating base 66I and to the circuit board. These wires are not shown in FIG. 6, but are schematically shown in FIG. 2 as 24W.

FIG. 7 illustrates an exemplary lighting unit including a base 72 combined with an HID or halogen spot lamp 74 and a circular fluorescent lamp 76. The base 72 serves as a central hub for radially supporting the circular fluorescent lamp via arms 72A and for axially supporting the halogen lamp via a socket (e.g., a standard Edison base socket) into which the halogen lamp is installed. An Edison screw base portion 72E is provided for installing the lighting unit in a standard lighting receptacle. The base 72 contains all necessary circuitry for the lamps. Readily available circular fluorescent and spot lamps may be used, making this a very economical lighting unit. Examples of readily available lamps that may be used include T9 CIRCLINE™ fluorescent, CDM35/PAR20 high intensity discharge, and MASTERLINE®PAR 20 halogen lamps from Philips Lighting Company.

FIGS. 8A and 8B illustrate adapters that may be used as an alternative to incorporating three way switches in the base of the lighting unit. Specifically, FIG. 8A illustrates an Edison base adapter for use with the Edison base connector shown in all of FIGS. 1-7. FIG. 8B illustrates a bayonet base adapter for use with lighting units having a bayonet base connector. In either case, the adapter is interposed between the connector portion of the lighting unit base and the socket in which the unit is installed.

FIG. 9 illustrates a symmetry axis 80 of a first lamp producing a wider area illumination of a first intensity and a symmetry axis 81 of a second lamp produces a narrower area illumination of a second intensity. The axes 80, 81 intersect at forty-five (45) degree intersection angle as shown. This facilitates a horizontal mounting of a lighting unit as exemplary shown in FIG. 10 with a modification of the lighting unit of FIG. 1 having its halogen lamp 14 being mounted at a forty-five (45) angle to its fluorescent lamp 16. With a horizontal mounted base, those having ordinary skill in the art will appreciate the lighting unit is particularly suitable as bathroom mirror and cabinet lighting, as kitchen cabinet and counter lighting, as kitchen cabinet cover and decorative kitchen ceiling lighting, and as curio and general lighting combinations.

FIG. 11 illustrates the axes 80, 81 intersecting at ninety (90) degree intersection angle as shown. This facilitates a horizontal mounting of a lighting unit as exemplary shown in FIG. 12 with a modification of the lighting unit of FIG. 1 having its halogen lamp 14 being mounted at a ninety (90) degree angle to its fluorescent lamp 16. Again, with a horizontal mounted base, those having ordinary skill in the art will appreciate the lighting unit is particularly suitable as bathroom mirror and cabinet lighting, as kitchen cabinet and counter lighting, as kitchen cabinet cover and decorative kitchen ceiling lighting, and as curio and general lighting combinations.

FIG. 13 schematically illustrates an exemplary lighting unit in accordance with the present invention that has an ellipsoidal envelope 90 attached to a plastic base 92. The envelope contains a halogen lamp 94 and a compact fluorescent lamp 96.

Base 92 includes a connector portion 92E for electrically connecting the lighting unit to a power source. Also, a pair of electric wires 94EW are provided for electrical connections from a circuit board (e.g., circuit board 63 shown in FIG. 6) seated in base 92 to the halogen lamp 94. In the illustrated embodiment, electric wires 94EW are electrically and mechanically attached to a pair of lead wires 94LW of halogen lamp 94 by soldering, welding, mechanical attachment (like crimping) or a combination thereof. Electric wires 94EW extend from lead wires 94LW through a hole of a mounting plate (e.g., base 661 shown in FIG. 6) of fluorescent lamp 96 to be mechanically attached to 94MA to base 92 using a crimped eyelet, a L-shape bending, or other mechanical means like twist lock etc of electric wires 94EW. Electric wires 94EW further connects halogen lamp 94 to the circuit board.

An adhesive 94G attaches halogen lamp 94 to envelope 90 and an adhesive 92G attaches bases 92 to a glass outer of envelope 90. The mechanical attachment 94MA of halogen lamp 94 to base 92 via electric wires 94EW as taught herein provides a safety feature that prevents the whole lighting unit from separating into multiple pieces in response to halogen lamp 94 separating from envelope 90 in case of a failure of adhesive 94G and/or base 92 separating from envelope 90 in case of a failure of adhesive 92G.

Those having ordinary skill in the art will appreciate the applicability of this safety feature to various other lighting units with the same or different shaped envelopes, lamp types (fluorescent lamps, halogen lamps, high intensity discharge lamps etc.), base types, wires types and attachment methodologies.

FIG. 14 illustrates a generic halogen reflector lamp 100 capable of emitting a natural daylight spectrum (e.g., a color temperature range of 3200K to 6500K) to thereby boost in the spot function of the second lamp as the second lamp reveals the unaltered true colors of the objects illuminated. The result is an increase in the visual acuity of the human eye and an improvement in a depth of focus.

Those having ordinary skill in the art will appreciate natural daylight spectrum can be generated by absorption of part of the visible filament emission spectrum by certain means, or by selective transmission of said part of said visible emission spectrum through the rear of a reflector surface 103 of lamp 100. In the embodiments described in this invention the transmitted light is preferrably absorbed by an absorbing medium, e.g. by a reflector made of absorbing glass, an absorbing (black) plate or a reflector shaped absorbing black sheet, which is placed in between the reflector and the corresponding light source contained in the embodiment described, with the aim to prevent undesired interaction between the light sources, as e.g. undesired color effects.

Specifically, in one embodiment, absorbing medium to generate the natural daylight can also be incorporated in the glass of the halogen burner 101 or the front cover plate 105, as e.g. is done by doping with Neodymium.

In an alternative embodiment, the absorbing medium can also consist of an coating 102 in the form of an absorption coating located on the outer surface of the halogen burner 101 and/or coating 106 in the form of an absorption coating located on either side of the flat or spherical shaped front glass 105 of the reflector lamp. In a preferred embodiment the absorbing coating primarily contains CoAl2O5 as absorbing medium.

In yet another embodiment, the light emitting filament of the halogen burner 101 in combination with inner parts of the halogen burner 101 is used as absorbing medium, by reflection of part of the light source visible emission spectrum back on the light source itself. The reflection thereby is preferably generated by coating 102 in the form of an interference coating located on the outer surface of said halogen burner 101. The halogen burner 101 then preferably is of spherical shape to maximize the reabsorption of the undesired part of the visible spectrum on the filament and inner parts of the halogen burner 101.

In yet another embodiment, lamp 100 includes a halogen burner 101 having coating 102 in the form of a IRC coating on its external surface for recycling heat emitted from halogen burner 101. In the case the filament is used as absorber of the undesired part of the visible spectrum, coating 102 can be single interference coating including a reflection coating on the surface of the halogen burner 101 combined with a IRC coating.

In the cases where an absorbing medium contained in the halogen lamp 100 as described above is used to generate the natural daylight spectrum the reflector 103 can be made of a reflecting metal (e.g., aluminum) to thereby prevent any light from leaving the back of the reflector. Alternatively, reflector 103 can be dichroic coated reflector consisting of absorbing glass or a plastic reflector whereby an absorbing shield 104 (e.g., a black shield) is used to absorb any heat and any light passing through a rear of reflector 103.

In one embodiment, lamp 100 can be specifically manufactured in accordance with commercially available lamps sold by the assignee of the present invention that incorporate the teachings of various halogen reflector lamps as would be appreciated by those having ordinary skill in the art. Furthermore, lamp 100 can further employ a commercially available bulb shield 105 as would be appreciated by those having ordinary skill in the art.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A lighting unit, comprising:
first and second lamps arranged for cooperatively providing lighting in a common space, said first lamp producing a wider area illumination of a first intensity and said second lamp producing a narrower area illumination of a second intensity;
a three-way switch for selectively energizing:
the first lamp; or
the second lamp; or
the first and second lamp, wherein the first intensity is a lower intensity and the second intensity is a higher intensity; and
a connector for electrically connecting the lighting unit to a power source.

2. The lighting unit of claim 1, wherein the first and second lamps have different color rendering indices.

3. The lighting unit of claim 1, wherein one of the first and second lamps comprises a discharge lamp.

4. The lighting unit of claim 3, wherein the discharge lamp comprises a fluorescent burner.

5. The lighting unit of claim 3, wherein the discharge lamp comprises a high-intensity discharge lamp.

6. The lighting unit of claim 3, wherein the discharge lamp comprises a metal-halide high-intensity-discharge lamp.

7. The lighting unit of claim 1, wherein at least one of the first and second lamps comprises a halogen burner.

8. The lighting unit of claim 1, wherein both of the first and second lamps comprise halogen burners.

9. The lighting unit of claim 1, wherein a first symmetry axis of the first lamp and a second symmetry axis of the second lamp intersect at a zero intersection angle.

10. The lighting unit of claim 1, wherein a first symmetry axis of the first lamp and a second symmetry axis of the second lamp intersect at a non-zero intersection angle.

11. The lighting unit of claim 1, further comprising:
a base to which the second lamp is mechanically attached.

12. The lighting unit of claim 11, further comprising:
electrical wires mechanically attaching lead wires of the second lamp to the base.

13. The lighting unit of claim 1, wherein the second lamp is a halogen lamp emitting a natural daylight spectrum in response to being energized by the three-way switch.

14. The lighting unit of claim 13, wherein the natural daylight spectrum has a color temperature ranging between 3200K and 6500K.

15. A lighting unit, comprising:
a discharge lamp and a halogen lamp arranged for cooperatively providing lighting in a common space, said discharge lamp producing a flood-lighting effect for illuminating a larger area when energized and said halogen lamp producing a spot-lighting effect for illuminating a smaller area when energized;
a three-way switch for selectively energizing:
the fluorescent lamp; or
the halogen lamp; or
the fluorescent lamp and the halogen lamp; and
a connector for mechanically and electrically connecting the lighting unit to a power source.

16. The lighting unit of claim 15, wherein the discharge lamp comprises a fluorescent burner.

17. The lighting unit of claim 15, wherein the discharge lamp comprises a high-intensity-discharge burner.

18. The lighting unit of claim 15, wherein a first symmetry axis of the discharge lamp and a second symmetry axis of the halogen intersect at a zero intersection angle.

19. The lighting unit of claim 15, wherein a first symmetry axis of the discharge lamp and a second symmetry axis of the halogen intersect at a non-zero intersection angle.

20. The lighting unit of claim 15, further comprising:
a base to which the halogen lamp is mechanically attached.

21. The lighting unit of claim 20, further comprising:
electrical wires mechanically attaching lead wires of the halogen lamp to the base.

22. The lighting unit of claim 15, wherein the halogen lamp emits a natural daylight spectrum in response to being energized by the three-way switch.

23. The lighting unit of claim 22, wherein the natural daylight spectrum has a color temperature ranging between 3200K and 6500K.

24. A lighting unit, comprising:
an envelope containing first and second lamps arranged for cooperatively providing lighting in a common space, said first lamp producing a wider area illumination of a first intensity and said second lamp producing a narrower area illumination of a second intensity;
a three-way switch for selectively energizing:
the first lamp; or
the second lamp; or
the first and second lamp, wherein the first intensity is a lower intensity and the second intensity is a higher intensity; and
a connector for electrically connecting the lighting unit to a power source.

25. The lighting unit of claim 24, wherein at least one of the first and second lamps is a discharge lamp.

26. The lighting unit of claim 24, wherein at least one of the first and second lamps is a halogen lamp.

27. The lighting unit of claim 24, wherein the envelope includes a surface on which is disposed a light transmissive coating for affecting dispersive characteristics of light emitted by at least one of the first and second lamps.

28. The lighting unit of claim 24, wherein the envelope includes a surface on which is disposed a light reflective coating for affecting directional characteristics of light emitted by at least one of the first and second lamps.

29. The lighting unit of claim 24, wherein the envelope includes a surface on which is disposed a coating for affecting color characteristics of light emitted by at least one of the first and second lamps.

30. The lighting unit of claim 24, wherein the envelope includes a surface on which is disposed a coating for affecting characteristics of light emitted by only the first lamp

31. The lighting unit of claim 24, wherein the second lamp comprises a reflector for directing emitted light through the envelope with a predetermined beam angle.

32. The lighting unit of claim 24, wherein at least one of the first and second lamps comprises a burner having a surface on which is disposed a coating for affecting color characteristics of light emitted by said burner.

33. The lighting unit of claim 32, wherein the coating is disposed on a surface of a halogen burner.

34. The lighting unit of claim 32, wherein the coating is disposed on a surface of a high intensity discharge burner.

35. The lighting unit of claim 24, wherein the three way switch is included in an adapter for attachment to the connector.

36. The lighting unit of claim 24, further comprising:
a base to which the envelope is attached, said base including said three way switch.

37. The lighting unit of claim 36, wherein the three way switch comprises electronic circuitry.

38. The lighting unit of claim 24, further comprising:
a base to which the envelope is attached, said base including an electronic ballast for at least one of the first and second lamps.

39. The lighting unit of claim 24, further comprising:
a base to which the envelope is attached, said base including a low voltage power converter for at least one of the first and second lamps.

40. The lighting unit of claim 24, wherein a first symmetry axis of the first lamp and a second symmetry axis of the second lamp intersect at a zero intersection angle.

41. The lighting unit of claim 24, wherein a first symmetry axis of the first lamp and a second symmetry axis of the second lamp intersect at non-zero intersection angle.

42. The lighting unit of claim 24, further comprising:
a base to which the halogen lamp is mechanically attached.

43. The lighting unit of claim 42, further comprising:
electrical wires mechanically attaching lead wires of the halogen lamp to the base.

44. The lighting unit of claim 24, wherein the second lamp is a halogen lamp emitting a natural daylight spectrum in response to being energized by the three-way switch.

45. The lighting unit of claim 44, wherein the natural daylight spectrum has a color temperature ranging between 3200K and 6500K.
